(19) United States
(12) Patent Application Publication
(10) Pub. No.: US 2024/0306627 A1
(43) Pub. Date: Sep. 19, 2024

(54) AGRICULTURAL SYSTEM FOR LOW AND HIGH-RESOLUTION SPOT SPRAYING AND METHOD FOR OPERATING SUCH A SYSTEM

(71) Applicant: ecoRobotix SA, Yverdon-les-Bains (CH)

(72) Inventor: Steve Tanner, Essert-Pittet (CH)

(21) Appl. No.: 18/675,757

(22) Filed: May 28, 2024

Related U.S. Application Data
(63) Continuation-in-part of application No. PCT/IB2022/061597, filed on Nov. 30, 2023.
(60) Provisional application No. 63/505,450, filed on Jun. 1, 2023.
(60) Provisional application No. 63/505,104, filed on May 31, 2023.

(30) Foreign Application Priority Data
Dec. 2, 2021 (CH) CH070685/2021
Mar. 24, 2022 (CH) CH000321/2022

(51) Int. Cl. A01M 7/00; A01B 63/02

(52) U.S. Cl. CPC A01M 7/0089; A01B 63/023; A01M 7/006; A01M 7/0082

(57) ABSTRACT

The present invention relates to an agricultural system for spraying an area of a cultivated field, including a spraying equipment. The spraying equipment comprises a first and a second supporting structures extending perpendicularly to the travel direction of the agricultural system when operating. The first supporting structure comprises a first array of nozzles separated from each other by a first distance while the second supporting structure comprises a second array of nozzles separated from each other by a second distance smaller than the first distance. The spatial resolution of spot sprays that may be sprayed by the second array of nozzles is higher than the spatial resolution of spot sprays that may be sprayed by the first array of nozzles when the first and second supporting structures are at the same height such that the first and second arrays of nozzles may perform respectively low and high-resolution spot sprays.

### CROSS-REFERENCE

This application claims the benefit of U.S. Provisional Application No. 63/505,104 filed May 31, 2023, and U.S. Provisional Application No. 63/505,450 filed Jun. 1, 2023, is also a continuation-in-part application of PCT International Application No. PCT/IB2022/061597 filed on Nov. 30, 2023, which claims the benefit of Switzerland Application No. CH070685/2021, filed Dec. 2, 2021, and Switzerland Application No. CH000321/2022, filed Mar. 24, 2022, each of which applications is incorporated herein by reference in its entirety.

### BACKGROUND

In conventional agricultural spraying systems, the nozzles are placed on a spray bar aligned orthogonally to the direction of displacement of the vehicle on which it is mounted, and parallel to the surface to be sprayed. The nozzles are aligned on the spray bar, and usually separated to each other by a uniform distance of typically 50 cm. Their divergent jet allows to apply the liquid on a given surface, which depends on the distance from nozzle to the target, usually the height distance from nozzle to the ground or plants (e.g., typically 50 to 100 cm). A conventional spray application is applied as homogeneously as possible on the complete surface under the spray bar, such application being called “full application” in the following description. For example, full application may be achieved by continuous spraying (e.g., spraying agrochemicals everywhere) and the nozzles are in continuous operation.

Recently, so-called smart sprayers have been developed. They include cameras forward-looking fixed along the spray bar and processing units configured to process images captured by the cameras to recognize the presence of specific plants in front of the spray bar. Such smart sprayers may conduct spot spraying which applies droplets of liquids on specific and predetermined locations through the use of valves (e.g. electromechanically controlled valves) which can switch the flow of the agrochemical on and off rapidly. The nozzles comprise electro valves which are switched on when a plant to be sprayed passes under the corresponding nozzle. However, the spatial precision and size of the corresponding spot sprays is limited due to the nozzle-to-nozzle distance of a conventional spray bar, typically 50 cm, and the limited plant mapping precision allowed by the camera system. These smart sprayers have therefore the inconvenient to use large amount of herbicide which are applied indiscriminately on the plants to be treated and to their surroundings which do not need any treatment, thereby wasting a significant amount of herbicide.

### SUMMARY

A need exists for more precise spot spray applications to reduce the agrochemicals usage. Agrochemicals, whether to promote growth (e.g., fertilisers), inhibit growth (e.g. herbicides) or prevent diseases or plagues (e.g., fungicides, insecticides, etc.), are typically applied to plants in liquid form using spraying. The agrochemicals are sprayed through nozzles which may be mounted on a support structure (e.g., spray bar), itself mounted on a spraying vehicle referred as a spraying system. In order to be more precise in spraying, the spray spot size is desired to be smaller (i.e., higher resolution), and be localized with greater accuracy. A smaller spray spot size (e.g., the unit of a sprayed area or an area sprayed by a single dose from a nozzle) is obtained with a higher nozzle density along the bar (e.g., smaller nozzle-to-nozzle distance such as only a few centimetres), and more narrow spray angles. However, the minimal angle is usually limited due to the need for the nozzle to produce droplets at a correct size. Small jet divergence angles have the tendency to produce too big droplets. Therefore, the only way to reduce the spray spot is to reduce the distance from nozzle to target, usually near the ground. In order to position the activation of the spot spray with greater accuracy, the object to be sprayed must first be mapped accurately in the coordinate system of the sprayer, and then its displacement must be tracked with accuracy so that the nozzle are activated at the right moment and right place.

In a conventional agricultural sprayer equipped with a single spray bar, spanning horizontally on a distance of several tenths of meters, the regulation of the distance of the spray bar to the ground is done actively by a regulation system. Such system may comprise distance sensors mounted along the spray bar for measuring the vertical distance of the spray bar to ground, and actuators configured to move the spray bar according to the output sensors, usually with a rotation around an axis parallel to the displacement (roll movement) and vertical translation. However, controlling the nozzle to ground distance on a large sprayer can be very difficult, as the spray bar height control system of sprayers has limited dynamical capability to follow the ground surface in the presence of shocks in the wheels of the vehicle, caused by bumps or holes in the terrain. Then, controlling a constant distance along the complete spray ramp in the presence of uneven field is very challenging. Finally, the inertial behaviour of a wide spray ramp may make it prone to collision with ground with short nozzle to ground distance.

Conventional systems may reduce the nozzle-to-nozzle distance to improve spray precision which has another negative aspect: the flow of each nozzle needs to be reduced accordingly to keep the same applied dose per unit area. However, such low-capacity nozzles may not be ideal for full applications (due to reduced efficiency of spraying continuously which does not require spatial resolution), and therefore the sprayer capability to perform full spray application, such as application of liquid fertilizer, or fungicide, is reduced. The smart sprayer loses its “universal” usage and two different sprayers are then required: one for full application, where spatial precision is not a concern, and one for spot spray application with the maximal precision or higher resolution in the spot spray operations.

To reach high spraying precision, a critical operation is to localize the objects to be sprayed with high accuracy. This localization is usually done with an image sensor fixed on the spray bar, which is accurately geo-referenced on it, usually by means of a geometric calibration, so that any detected object is correctly mapped and its relative displacement in the rear direction can be tracked until it is sprayed. However, in current sprayers, the cameras are tilted so as to look forward, which allows a detection sufficiently early to leave enough time for the image processing to be done. Unfortunately, tilting the camera in the horizontal direction results in poor object mapping due to the absence of distance measurement with a standard image sensor. The distance must be approximated, resulting in important errors. Furthermore, any ground irregularity translates directly into positioning errors. Finally, poorly estimated object to camera distance may further cause scaling errors in any visual odometry algorithm used to track the relative movement of the sprayer equipment with ground.

The present disclosure may solve the drawbacks of a convention sprayer system by providing an agricultural system for high-resolution spot spraying adapted to detect very small plants, and to perform accurate plant/object mapping and tracking. In particular, the agricultural system herein may be adapted to perform at least two spraying application modes, one is full application of liquid, for instance to spray fertilizer or fungicide uniformly, continuously or at lower spatial resolution, and the other mode is high-resolution spot spraying application, for instance of non-selective herbicide for selective weeding operation, or insecticide on the crop plants only.

In an aspect of the present disclosure, an agricultural system for spraying an area of a cultivated field, including a spraying equipment is provided. The spraying equipment comprises a first and a second spray structure (e.g., spray bar), a first and a second spray structure (e.g., spray bar) height control system, a camera system, a processing unit, one or more object tracking units, and a first and a second nozzles array control unit.

In some embodiments, the first and second spray bar may extend perpendicularly to the travel direction of the agricultural system when operating. The first spray bar comprises a first array of nozzles separated from each other by a first distance while the second spray bar comprises a second array of nozzles separated from each other by a second distance smaller than the first distance such that the spatial resolution of spot sprays that may be sprayed by the second array of nozzles is higher than the spatial resolution of spot sprays that may be sprayed by the first array of nozzles when the first and second spray bars are at the same height such that the first and second arrays of nozzles may perform respectively low and high-resolution spot spraying. The first and second spray bar height control system comprise each at least one height actuator so as to control independently the height of the first and second spray bars with reference to the ground.

The camera system comprises one or more camera modules having each a camera arranged to capture images of objects, for example plants and/or part of plants, and of the ground, ahead of the first and second spray bars. in the travel direction of the agricultural system. The processing unit is configured to run an image recognition software to identify the objects on the acquired images and to generate a mapping of these objects on the coordinate system of the spray bars. The object tracking unit is configured to continuously track the position of these objects on said mapping. The first and second nozzles array control unit are configured to control each nozzle of respective first and second array of nozzles as to selectively control the nozzles of the first and second arrays of nozzles to perform low and/or high-resolution spot spraying on different objects as a function of the position of these objects on the mapping.

In an embodiment, the spray bar height control system comprises one or more primary height actuators arranged to control the height of both first and second spray bars with reference to the ground and one or more secondary height actuators arranged to move one of said first and second spray bars relative to the other of said first and second spray bars.

In an embodiment, the spraying equipment further comprises distance measurement sensors arranged to measure the distance from the first and/or the second spray bar to the ground surface to determine an estimated object plane. The distance measurement sensors are for example mounted along the first and second spray bars. The distance measurement sensors are arranged to send distance information to the first and a second nozzles array control unit to regulate the height of said first and second spray bars as a function of said distance information.

In an embodiment, the camera module or each camera module further comprises a 3D depth sensor arranged to measure the distance between any point of the objects acquired by the camera and said 3D depth sensor to generate a depth map on which is mapped said objects in the tri-dimensional coordinate system of the first and second spray bars, for correction of any horizontal mapping errors caused by the height difference between said estimated object plane and the real object positions to improve the spraying accuracy.

In an embodiment, the 3D depth sensor is a laser scanning system with time of flight (LIDAR) or triangulation, a stereovision system, a time-of-flight camera, or a structured light depth camera.

In an embodiment, the camera module or each camera module comprises at least two cameras arranged to acquire simultaneously respectively a first and a second set of images of the ground ahead of the first and second spray bars, and a stereovision computing unit configured to compute the depth map of the objects as a function of said first and second sets of images.

In an embodiment, the spraying equipment includes a first and a second fluid distribution systems arranged to provide to respective first and second arrays of nozzles a different chemical mixture at a possibly different pressure, so as to enable the spraying equipment to spray two different chemical preparations in a single passage, for example simultaneously. Each chemical preparation includes for example herbicide, fungicide, insecticide, fertilizer, growth stimulant or nematocide.

In an embodiment, the first spray bar comprising the first array of nozzles is adapted to be extended laterally, either by translation or by unfolding of one or several first spray bar extensions. These bar extensions are equipped with the low-resolution nozzle array and with range measurement sensors, so as to provide a larger working width for full spray application to achieve continuous and homogeneous spray application without low and high-resolution spot spraying.

In an embodiment, the camera module or each camera module is rotatably mounted on a support of the spraying equipment, for example on the first spray bar, to provide varying tilt angle of the optical axis of the camera of the camera module or each camera module with reference to the ground to modify the distance between an edge of the captured images of an area of a cultivated field by the camera and the projection on the ground of said first and second spray bars.

In an embodiment, the camera module or each camera module is mounted on a supporting structure (e.g., mast) extending forward from the first and second spray bars. For example, the mast may comprise one or more rotatable joints. The rotatable joint may be a motorized rotation system for controlled, accurate and repeatable rotation of the mast around an axis extending perpendicularly to the travel direction of the agricultural system and allowing multiple positions between two extreme positions, thus offering varying tilt angle for the camera module. In some cases, the projection angle or viewing angle of the camera module may be adjusted or controlled in one or more directions (e.g., pitch, yaw) with respect to the spraying system. In some cases, the projection angle of the camera unit may be adjusted by controlling the movement of the rotatable joint of the mast. For example, the rotatable joint may be actuated by an actuator to rotate the camera module with respect one or more axes (e.g., roll axis, pitch axis, or yaw axis). In some cases, the actuator may be a motor. In some cases, the motor may be configured to actuate the rotatable joint or camera module to rotate about a pitch axis. In some cases, the motor may be configured to actuate the rotatable joint at a base of the mast such that a height of the camera module may be adjusted.

In another aspect of the present disclosure, a method is provided for operating the agricultural system using visual odometry to detect and track the tri-dimensional movement of the objects in the tri-dimensional (3D) coordinate system of the first and second spray bars such that the first and second nozzles array control units timely control the first and second array of nozzles according to the position of said objects in said 3D coordinate system. The visual odometry comprises the steps of: i. capturing with the camera a first image of the ground and of the objects on the ground; ii. simultaneously capturing with a 3D depth sensor a depth map of the ground and the objects captured in the first image; iii. merging the first image with the depth map to obtain a 3D image; iv. extracting on said 3D image a set of features, such as contour, an edge or any landmark of an object, for features tracking; v. repeating steps i to iv and tracking the movement of the extracted features between two consecutive 3D images as the agricultural system moves along its travel direction to compute the movement of said extracted features in said 3D coordinate system.

In an embodiment, the optical axis of the camera of the camera module or each camera module is tilted around its rotation axis to set a first distance and a second distance where the second distance is smaller than the first distance. The distance is the distance between an edge of the captured image of an area of a cultivated field and the projection on the ground of said first and second spray bars. The optical axis is adjusted to set the first distance when only low-resolution spot spraying is used, thereby increasing the time for computation and consequently to allow speed increase of the agricultural system. The optical axis is adjusted to set the second distance when only high-resolution spot spraying is used, where the speed of the agricultural system is limited to allow high-precision mapping of the plants in the ground reference.

In an embodiment, the camera module or each camera module includes a first camera sensitive to a first set of spectral bands, a second camera sensitive to a second set of spectral bands, a 3D optical depth sensor sensitive to a third set of spectral bands, and one or more irradiation elements. The spectral band emission of said one or more irradiation elements, combined together, covers the entire spectral bands of the first camera, the second camera and the 3D depth sensor. Each irradiance element may be turned on when the pixels of the cameras or the 3D depth sensor are integrating light using the corresponding spectrum.

In another aspect of the present disclosure, a method or system for precise and fast stabilization of the high-resolution nozzle array to ground distance in uneven terrains is provided. The system may comprise two independent active height control systems for each one of the high and low-resolution nozzle arrays. The first nozzle array (low resolution) being fixed directly on the first spray bar structure, its distance to ground is set by a first regulator controlling the stability of the first spray bar by means of a first set of actuators, generally controlling the roll angle and the vertical position of the bar.

The distance to ground control may be different for the high-resolution application and low-resolution application. For instance, as the distance to ground of this first nozzle array is significant, a very accurate regulation may not be required due to the low-resolution spraying, and the impact of the terrain irregularities on the spray accuracy may not degrade significantly the precisions of this low-resolution spot spray. The distance to ground control for the second (high resolution) nozzle array may require more precise control at granular level as the second nozzle array needs to be controlled to be placed and maintained much closer to ground in order to guarantee high spot spray accuracy.

In some embodiments, the distance to ground control for the second (high resolution) nozzle array may be achieved by means of two elements. The first is to split this high resolution nozzle array into smaller segments or modular components, each typically of a few meters long, and each having its own active height control system, so that even in the presence of uneven terrain, the high resolution nozzles follow the surface profile by the individually adjusted modular segments. The second is to pilot independently these height controllers by the information provided by the 3D depth sensors located in front of the corresponding segment. Additional height information provided by the height sensors regulating the first spray bar can also be used.

In another aspect of the present disclosure, system herein may take into account the mechanical coupling existing between the two position-regulated spray bars for the active control of the bars. By factoring in the mechanical coupling between the two position-regulated spray bars, the control performance of the system may be improved as vertical movement of the individual segments of the second spray bar can result into a force applied to the first spray bar which may inject a perturbation in its height control. The control system herein may obtain such mechanical coupling effect based on the perturbation generated by the output of the height controller of each second spray bar segment. Such perturbation information may be obtained and may be used to compensate said perturbation in the controller method of the first spray bar height controller. Similarly, any regulation movement of the first spray bar may translate into a perturbation in the position of each segment of the second spray bar. This perturbation being known, it can be compensated in the controller method of each segment of the second spray bar. This mutually mechanically-coupled system can be described mathematically and the regulation methods of each spray bar height controller can be designed accordingly.

In an embodiment, the second array of nozzles comprises several segments comprising each a series of nozzle. The second spray bar height control system comprises one actuator per segment to allow fine control of the nozzles-to-ground distance of each segment independently from the others.

In an embodiment, the first spray bar height control system regulates the distance between the first spray bar and the ground as a function of a combination of the information provided by distance measurement sensors, by 3D depth sensors, and by the second spray bar height control system, in particular the position, speed and/or acceleration information of the second spray bar and/or each of several segments of said the second spray bar.

In an embodiment, the second spray bar height control system regulates the distance between the second spray bar and/or each of several segments of said the second spray bar with the ground as a function of a combination of the information provided by distance measurement sensors, by 3D depth sensors, and by the first spray bar height control system, in particular the position, speed and/or acceleration information of the first spray bar.

In an embodiment, the first and second arrays of nozzles are supplied either by a same liquid distribution system, or by their respective liquid distribution systems. The first and second control units are operated to control each nozzle of respective first and second arrays of nozzles to perform on the cultivated field any of the following operations: a. performing low-resolution and high-resolution spot spraying simultaneously; b. performing low-resolution spot spraying while high-resolution spot spraying is not performed; c. performing high-resolution spot spraying while the low-resolution spot spraying is not performed; d. performing a continuous and homogeneous spray application with the first array of nozzles while the second array of nozzles is not used; e. performing a continuous and homogeneous spray application with the second array of nozzles while the first array of nozzles is not used; f. performing a continuous and homogeneous spray application with the first array of nozzles while the second array of nozzles performs high-resolution spot spraying; g. performing a continuous and homogeneous spray application with the second array of nozzles while the first array of nozzles performs low-resolution spot spraying, and h. performing a continuous and homogeneous spray application with the first and second arrays of nozzles

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Some novel features of the invention are set forth in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a schematic lateral view of an agricultural system comprising a spraying equipment according to an embodiment.

FIG. 2 shows a schematic perspective view of a portion of the agricultural spraying equipment of FIG. 1.

FIG. 3 shows a schematic lateral view of the first and second spray bars with the high- and low-resolution nozzle arrays, the camera module and associated systems to process the images and control the spraying equipment according to an embodiment.

FIG. 4 shows a schematic diagram of the elements associated to one camera module of the spraying equipment according to an embodiment.

FIG. 5A shows a schematic front view of one camera with the various mapping errors due to projection occurring without range sensor.

FIG. 5B shows a similar view of FIG. 5A with exact mapping when a 3D range sensor is used, according to an embodiment.

FIG. 6 shows a schematic rear view of the spraying equipment in a folded configuration, according to an embodiment.

FIG. 7 shows the spraying equipment of FIG. 6 in a deployed configuration.

FIG. 8A shows a schematic lateral view of the spray bar with the high- and low-resolution nozzle arrays, when the camera module is oriented to maximize the speed of the spraying equipment.

FIG. 8B shows a similar view when the camera module is oriented to maximize the spray precision.

### DETAILED DESCRIPTION OF THE INVENTION

While preferable embodiments of the disclosure have been shown and described herein, it will be obvious to those skilled in the art that such embodiments are provided by way of example only. Numerous variations, changes, and substitutions will now occur to those skilled in the art without departing from the present disclosure. It should be understood that various alternatives to the embodiments of the invention described herein may be employed in practicing the invention.

The present disclosure provides systems and methods for controlling an agricultural system to be adapted to perform at least two spraying application modes, one is full application of liquid, for instance to spray fertilizer or fungicide uniformly, continuously or at a lower spatial resolution, and the other mode is high-resolution spot spraying application, for instance of non-selective herbicide for selective weeding operation, or insecticide on the crop plants only. In some cases, the liquid can have different mechanical properties, e.g., viscosity, and the spraying application of the liquid using the different spraying application modes may be based on the types of agrochemical. For example, full application of liquid to spray uniformly, continuously or at lower spatial resolution may be utilized to spray fertilizer or fungicide, and the high-resolution spot spraying application may be utilized for non-selective herbicide for selective weeding operation, or insecticide on the crop plants only.

Droplets may take a wide variety of shapes; nonlimiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more surfaces of a droplet nozzle.

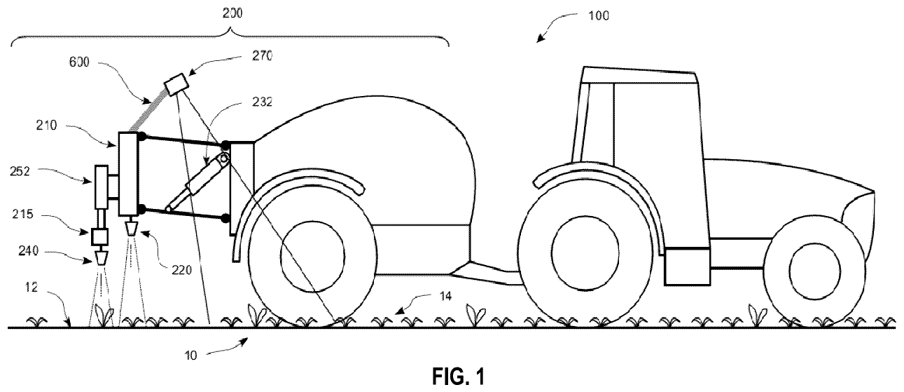

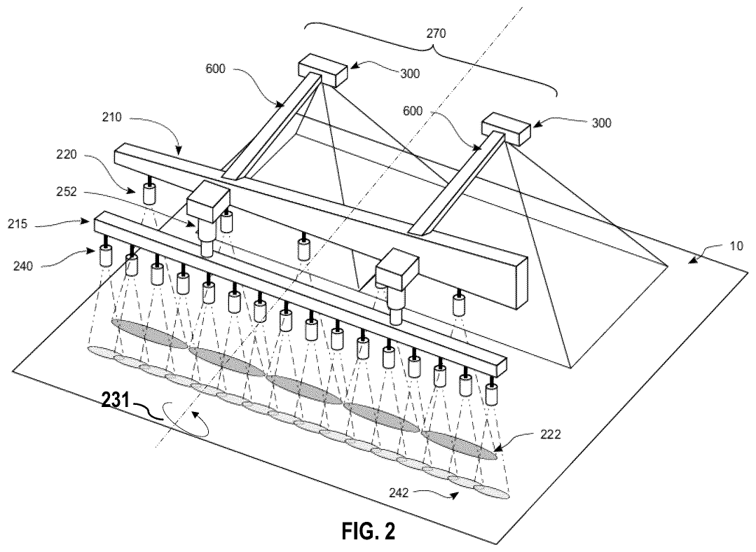

In some embodiments, the agricultural system for spraying an area of a cultivated field may comprise a spraying equipment. The spraying equipment comprises a first and a second spray structure (e.g., spray bar), a first and a second spray structure (e.g., spray bar) height control system, a camera system, a processing unit, one or more object tracking units, and a first and a second nozzles array control unit. With reference to FIG. 1 and FIG. 2, the agricultural system 100 comprises an agricultural spraying equipment 200 that may comprise a first and a second spray structure (e.g., spray bar) 210, 215 extending substantially perpendicularly to the travel direction of the agricultural system 100 when operating. The first spray bar and the second spray bar are also referred to as a first supporting structure and a second supporting structure which are utilized interchangeably throughout the specification. The first spray bar 210 comprises a first array of nozzles 220 separated from each other by a first distance while the second spray bar 215 comprises a second array of nozzles 240 separated from each other by a second distance. The second distance may be smaller than the first distance. The first and second arrays of nozzles 220, 240 may advantageously perform respectively low and high-resolution spot spraying 222, 242. In some cases, the spatial resolution of spot sprays 242 that may be sprayed by the second array of nozzles 240 is higher than the spatial resolution of spot sprays 222 that may be sprayed by the first array of nozzles 220 when the first and second spray bars 210, 215 are at the same height.

The nozzle-to-nozzle distance of the low resolution array of nozzles is greater than that of the high resolution array of nozzles. In some cases, a low resolution array of nozzles may have a nozzle to nozzle distance in the range of 20 cm-80 cm, or any number below 20 cm or above 80 cm. In some cases, a high-resolution array of nozzles may have a nozzle to nozzle distance in the range of 2 cm to 5 cm of any number below 2 cm or above 5 cm. In some cases, the nozzle-to-nozzle distance of the low resolution array of nozzles to the nozzle to nozzle distance of the high resolution array may be any ratio greater than 1. As an example without limiting, a high-resolution array of nozzles may have a nozzle to nozzle distance of about 50 cm and a low resolution array of nozzles may have a nozzle to nozzle distance of about 5 cm.

In some cases, the spatial resolution and/or the spot size of the high-resolution or low resolution spray may be determined based at least in part on one or more parameters of the spray system, such as pressure for dispensing the droplet, valve activation duration, size of nozzles, nozzle-to-nozzle distance, height of the nozzle (e.g., distance to the ground), and the like. A resolution or size of the locations where the droplet deposited on a substrate can be adjusted. A resolution may refer to a spacing between neighboring locations on the substrate where the droplet deposited to. A size may refer to the total number of locations for receiving the droplets. A size of a spot spray may refer to the region on the ground or plant that receives the liquid. The resolution of spray application may depend on the arrangement of the nozzles. For example, the resolution of spray application may be associated with a spacing between the nozzles in an array and a nozzle to ground distance.

In some cases, the nozzle-to-nozzle distance or resolution of the array of nozzles may be determined such that the low-resolution array of nozzles may be suitable for a full application or to spray liquid in a continuous and homogeneous spray application. In some cases, the nozzle-to-nozzle distance and/or spray duration may be determined such that the high-resolution array of nozzles may be suitable for performing a high-resolution spot spraying.

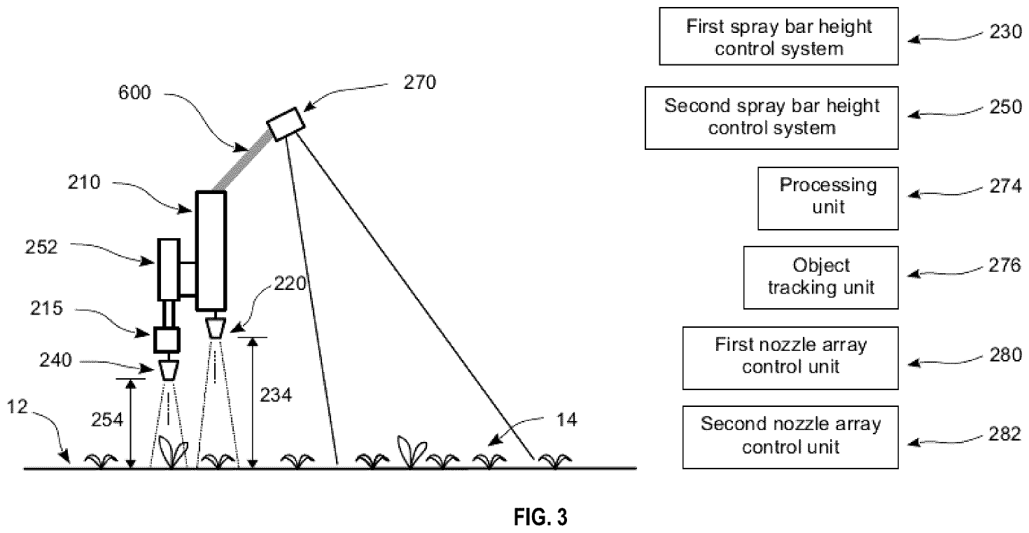

Referring to FIG. 3, the agricultural spraying equipment 200 also comprises a first spray bar height control system 230 comprising at least one height actuator 232 (FIG. 1), and a second spray bar height control system 250 comprising at least one height actuator 252 so as to control independently the height of the first and second spray bars 210, 215 with reference to the ground 12.

As shown in FIG. 1 and FIG. 2, the height from the ground 12 of the first spray bar 210 may be controlled for example by means of height and roll actuators. The height and roll actuators may effectuate a vertical motion of the spray bar and a rotational motion of the spray bar about a roll axis 231 thereby adjusting a nozzle to ground distance. In the illustrated example, at the rear of the first spray bar 210 are mounted height actuators 252 supporting the second spray bar 215 with the high-resolution nozzle array 240 so as to allow different nozzle-to-ground distances for the first spray bar and the second spray bar. For example, the nozzle-to-ground distance for the high-resolution nozzle array 254 may be smaller than the nozzle-to-ground distance for the low-resolution nozzle array 234 by disposing the first bar 210 and the second spray bar 240 on opposing sides of the height actuators 252. For example, a relative vertical distance between the low-resolution nozzle array and the high-resolution nozzle array may be controlled by the height actuators 252.

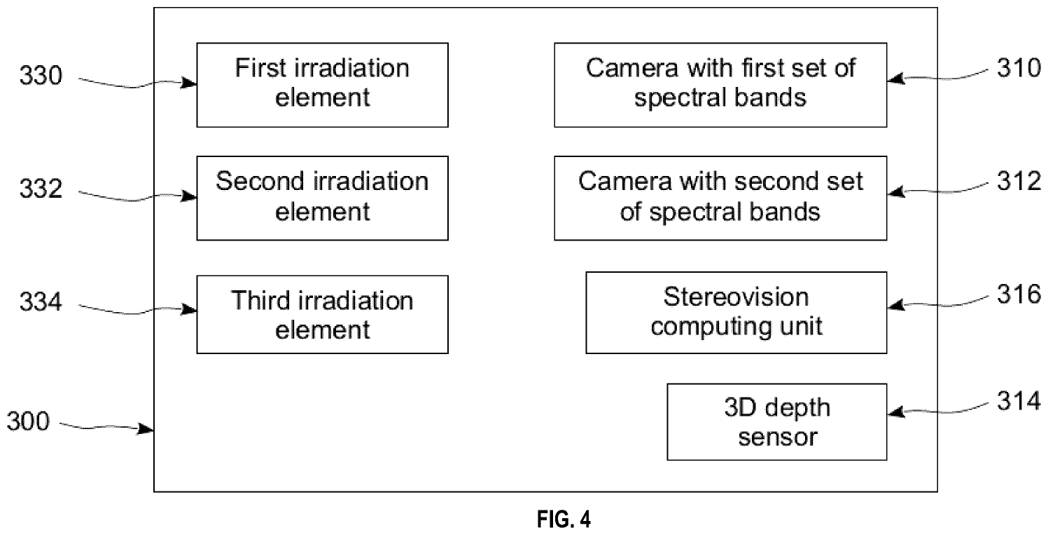

With reference to FIG. 2, the agricultural spaying equipment further comprises a camera system 270 with one or more camera modules 300. Each camera module 300 comprises at least one a camera 310 (FIG. 4) arranged to capture images of objects, for example plants 14 and/or part of plants 16, and of the ground 12, ahead of the first and second spray bars 210, 215 in the travel direction of the agricultural system 100. Advantageously, each camera module 300 may comprise other cameras, sensors and light sources as described subsequently with reference to FIG. 4 to acquire images of high quality independently of the light conditions.

Each camera module 300 is mounted at the end of a camera mast 600 and looking forward as shown in FIG. 2. the camera module or each camera module is mounted on a support or a supporting structure (e.g., mast 600) extending forward from the first and second spray bars. For example, the mast may comprise one or more rotatable joints. The rotatable joint may be a motorized rotation system for controlled, accurate and repeatable rotation of the mast around an axis extending perpendicularly to the travel direction of the agricultural system and allowing multiple positions between two extreme positions, thus offering varying tilt angle for the camera module. In some cases, the projection angle or viewing angle of the camera module may be adjusted or controlled in one or more directions (e.g., pitch, yaw) with respect to the spraying system. In some cases, the projection angle of the camera unit may be adjusted by controlling the movement of the rotatable joint of the mast. For example, the rotatable joint may be actuated by an actuator to rotate the camera module with respect one or more axes (e.g., roll axis, pitch axis, or yaw axis). In some cases, the actuator may be a motor. In some cases, the motor may be configured to actuate the rotatable joint or camera module to rotate about a pitch axis. In some cases, the motor may be configured to actuate the rotatable joint at a base of the mast such that a height of the camera module may be adjusted.

Referring to FIG. 3, the agricultural spraying equipment comprises a processing unit 274 configured to run an image recognition software to identify one or more objects on the acquired images and to generate a depth map of these objects on the 3D coordinate system of the spray bars. The spraying equipment further comprises one or more object tracking units 276 and a first and a second nozzles array control unit 280, 282. The tracking unit or each tracking unit 276 is configured to continuously track the position of these objects on the depth map.

The system may utilize any suitable computer vision or image processing techniques to identify the one or more objects in the acquired camera image (e.g., video) and/or generate a 3D depth map. In some cases, the camera may be a plenoptic camera having a main lens and additional micro lens array (MLA). The plenoptic camera model may be used to calculate a depth map of the captured image data. In some cases, the image data captured by the camera may be grayscale image with depth information at each pixel coordinate (i.e., depth map). The camera may be calibrated such that intrinsic camera parameters such as focal length, focus distance, distance between the MLA and image sensor, pixel size and the like are obtained for improving the depth measurement accuracy. Other parameters such as distortion coefficients may also be calibrated to rectify the image for metric depth measurement. In some cases, the image data may be received and processed by the processing unit 274 and the tracking unit 276. For example, pre-processing of the capture image data may be performed. In an embodiment, the pre-processing algorithm can include image processing algorithms, such as image smoothing, to mitigate the effect of sensor noise, or image histogram equalization to enhance the pixel intensity values. Next, optical approaches may be employed to generate a depth map of the field. In some cases, computer vision (CV) techniques or computer vision systems may be used to process the sensing data to extract high-level understanding of the field, object detection, object classification, extraction of the scene depth and estimation of relative positions of objects, extraction of objects' orientation in space. For example, the CV output data may be generated using passive methods that only require images. Passive methods may include, for example, object recognition, stereoscopy, monocular shape-from-motion, shape-from-shading, and Simultaneous Localization and Mapping (SLAM). Alternatively, active methods may be utilized which may require controlled light to be projected into the target scene and the active methods may include, for example structured light and Time-of-Flight (ToF). In some cases, computer vision techniques such as optical flow, computational stereo approaches, iterative method combined with predictive models, machine learning approaches, predictive filtering or any non-rigid registration methods may be used to generate the 3D depth map.

A 3D depth map may comprise identity of one or more objects and the location (x, y, z coordinates) of the object. Upon generation of the 3D depth map, the first and second nozzles array control units 280, 282 are configured to control each nozzle of respective first and second arrays of nozzles 220, 240 as to selectively control the nozzles of the first and second arrays of nozzles 220, 240 to perform low and/or high-resolution spot spraying 222, 242 on different objects as a function of the position of these objects on the 3D depth map with respect to the position of the first and second spray bars 210, 215.

The nozzle to ground distance (i.e., height of the nozzle array) may be measured by a distance sensor and/or the camera module. In some cases, the first spray bar height control system 230 is configured to receive height information from a 3D depth sensor 314 of the camera modules 300 and/or from other distance measurement sensors placed along the first spray bar 210 to measure its distance from the ground 12 in various places of the spray bar. In some cases, distance measurements obtained from the 3D depth sensor 314 of each camera module 300 (e.g., derived from the depth map) and the distance measurements (e.g., direct vertical distance or height of the spray bar) obtained from other distance measurement sensors placed along the spray bar, such as ultrasound, radiowave or optical sensors, may be combined together to improve the measurement accuracy.

In some cases, multiple measurements of distances at multiple points along the spray bar (e.g., first spray bar) may be acquired to obtain a ground profile under the bar, which may not be always flat. In some cases, the control system 230 may compute an average distance, or a minimal distance to represent a height of the first spray bar (low resolution array support structure) to the ground.

Next, the control system 230 may generate control commands for the spray bar height and roll actuators 232 to control a nozzle-to-nozzle distance for the low-resolution array thereby maintaining the low resolution nozzle array at a constant desired distance 234 from ground. In some cases, a roll actuator may be controlled to rotate the spray bar around an axis parallel to the movement of the spraying equipment (e.g., roll axis 231 in the middle of the first spray bar) so as to delimit two sides of the spray bar (e.g., a left and a right side). The height actuator may be controlled to effectuate a vertical movement (e.g., up and down) the spray bar. The controller may generate the control command using a feedback loop to minimize the difference between a desired distance 234 from ground and the real distance measured by the distance sensors. In some cases, the controller may generate command to control the roll actuator to minimize the difference of height at the left and right sides of the spray bar respectively, and control the height actuator to minimize the difference between a desired distance and the average of the distances measured on the left and right sides of the spray bar.

In some embodiments, the control system 230 may also take into account the mechanical coupling existing between the two position-regulated spray bars for the active control of the bars. By factoring in the mechanical coupling between the two position-regulated spray bars, the control performance of the system may be improved as vertical movement of the individual segments of the second spray bar can result into a force applied to the first spray bar which may inject a perturbation in its height control. For example, the control system 230 may obtain such mechanical coupling effect based on the perturbation generated by the output of the height controller of the second spray bar or modular components of the second spray bar. Such perturbation information may be obtained (such as stored in a look-up table) and may be used to compensate the perturbation in the control algorithm of the first spray bar height controller.

The high-resolution nozzle array height control system 250 performs similar control algorithm but on the high-resolution nozzle array to maintain a constant distance 254 with ground. The sensor processing unit 274 is configured to perform object detection and generate a 3D depth map, and to transmit their coordinates to the object tracking unit 276 which tracks their relative displacement until they reach the nozzles. The first and second nozzles array control units 280, 282 transform a plant presence passing under the nozzles into opening and closing commands for the nozzles. Similarly, any regulation movement of the first spray bar may translate into a perturbation in the position of each segment of the second spray bar. This perturbation being known, it can be compensated in the controller method of each segment of the second spray bar.

With reference to FIG. 4, data of the 3D depth sensor 314 of the camera module 300 is sent to the processing unit which generates the depth map of the ground and its objects. The camera module 300 may comprise a second camera 312 with a second set of spectral bands 312, for instance in the infrared. In another embodiment, two cameras are used to simultaneously acquire the same images from two distinct positions and to calculate the depth map using a stereovision algorithm 316.

In a preferred embodiment, the camera module 300 further comprises irradiation elements (illumination elements) 330, 332, 334, whose respective spectral emission band covers at least all the bands of the cameras and 3D optical depth sensor. These irradiation elements such as light emitting devices (LEDs) may provide powerful light levels to allow the cameras to acquire images with a short exposure time to avoid image blur when the agricultural system 100 travels at high speed. In some cases, the system may provide power conservation capacity by enabling the irradiation elements to emit light only during the exposure times of the cameras thereby reducing power consumption. In some cases, an infrared (IR) camera may be used to perform IR imaging. The IR cameras may be able to detect specific properties of plants or be used to better discriminate plants and ground. Any IR camera known or later developed in the art may be used. IR images may be used in conjunction with or instead of visible spectra images. In the case of IR imaging, active illumination may be employed. An IR illuminator is a tool that emits light in the infrared spectrum. For example, the IR illuminator may generate infrared radiation or electromagnetic radiation where wavelengths may range from 700 nanometers to 5 micrometers. The wavelength range may be selected so the IR camera is suitable for detecting plants and ground. In some embodiments, one or more IR illuminators may flash infrared light to the scene to assist in acquiring IR images with adequate quality. The IR illuminators may allow night vision to function with no visible light on the scene and drastically improve the sensitivity of the camera device. The IR illuminator can be of any kind emitting light in the infrared spectrum. For example, the illuminator may contain arrays of IR LEDs, and may have an illumination range suited to illuminate the scene acquired by the IR camera.

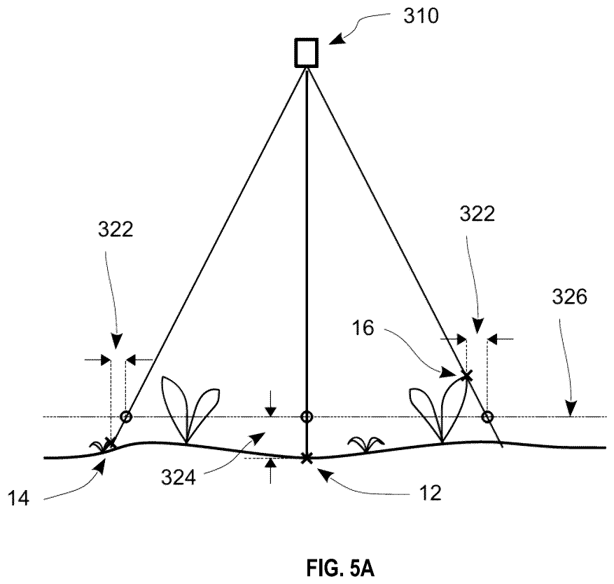

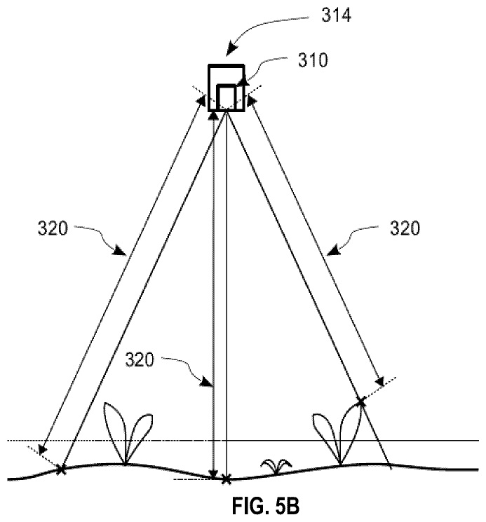

The camera module may comprise a 3D depth sensor 314 to improve the spray precision. As illustrated in FIG. 5A and FIG. 5B, with a standard camera 310, as shown in FIG. 5A, the difference of vertical distance from camera to a supposed or estimated object plane 326 and camera to the real objects 12, 14, 16 results in incorrectly mapped objects in longitudinal 322, lateral and vertical 324 directions. These errors degrade the object mapping and the visual odometry when this latter is used. The estimated object plane 326 may be a result of vertical distance from the spray bar to the ground that is measured by the distance sensors mounted along the spray bar. To avoid these projection errors, using a 3D depth sensor such as a 3D range sensor 314, as shown in FIG. 5A, whose optical axis is located as much as possible near the camera optical axis, allows to register the 3D range information to the camera image frame, and thus to obtain the exact distance 320 between a point in the image and the camera. The exact distance measurement between the objects and the camera beneficially allows to position in 3D space each point of the image and therefore to compute the correct longitudinal, lateral and vertical mapping of each point of the camera image.

As described above, the 3D depth sensor 314 measures a distance between any point of the objects on the acquired camera image (e.g., 2D camera image) to generate a 3D map. The 3D map is used for correction of a horizontal mapping error caused by a height difference between the estimated object plane and the real object position. The 3D map is used to map any points of the objects on the coordinate system of the spray equipment. The 3D depth sensor may be any suitable type of sensor providing a distance information for a multitude of points of the image. Such a sensor can be an optical sensor such as stereoscopic vision sensor, a time of flight (ToF) image sensor, a light detection and ranging (Lidar) sensor, or an array of ultrasound sensors providing a multitude of distance measurements. Lidar can be used to obtain three-dimensional information of an environment by measuring distances to objects. The 3D depth sensor may be disposed at the near the camera sensors. In some cases, the 3D depth map may be generated using a single modality sensor data (e.g., image data, Lidar, proximity data, etc.). Alternatively, the 3D depth map may be generated using multi-modality data. For example, the image data and 3D point cloud generated by the Lidar system may be fused using Kalman filter or deep learning model to generate a 3D map.

In some embodiments, the system of the present disclosure may utilize machine learning and AI technologies to identify object (e.g., types of plants, weed, crop, etc.) based at least in part on camera image data or IR image data. In some cases, the AI techniques may optimize fusion of multimodal data or data from various sources. The detection techniques may employ one or more trained predictive models to output predicted plant, and/or details about the plant (e.g., dimension, location, type of plant, etc.). The input data may include at least camera image data or IR image data. In some cases, the input data may also include data collected from other sensors (e.g., 3D depth sensor) and/or external sources (e.g., knowledge database).

The one or more predictive models can be trained using any suitable deep learning networks. For example, the deep learning network may employ U-Net architecture to process the image data. A U-Net architecture is essentially a multi-scale encoder-decoder architecture, with skip-connections that forward the output of each of the encoder layers directly to the input of the corresponding decoder layers. As an example of a U-Net architecture, unsampling in the decoder is performed with a pixelshuffle layer which helps reducing gridding artifacts. The merging of the features of the encoder with those of the decoder is performed with pixel-wise addition operation resulting in a reduction of memory requirements. The residual connection between the central input frame and the output is introduced to accelerate the training process.

In some embodiments, the object detection model may have a two-stage structure comprising a backend model which is a feature extractor and an object detector. The backend model may provide input to the object detector which is referred to as the head of the network. In some cases, unlike conventional two-stage structure that uses heavy head design of Faster R-CNN (Region-based Convolutional Neural Network) or R-FCN (Region-based Fully Convolutional Network), the object detection model herein may have a light-head R-CNN architecture where the detector is able to strike an optimal tradeoff of speed and accuracy, not matter a large or small backend network is used. For example, the object detection model may comprise a ResNet as backend and modified version of Faster RCNN as its head. This design may greatly reduce the computation of following Rol-wise subnetwork and make the detection system memory-friendly.

The deep learning model can employ any type of neural network model, such as a feedforward neural network, radial basis function network, recurrent neural network, convolutional neural network, deep residual learning network and the like. In some embodiments, the deep learning algorithm may be convolutional neural network (CNN). The model network may be a deep learning network such as CNN that may comprise multiple layers. For example, the CNN model may comprise at least an input layer, a number of hidden layers and an output layer. A CNN model may comprise any total number of layers, and any number of hidden layers. The simplest architecture of a neural network starts with an input layer followed by a sequence of intermediate or hidden layers, and ends with output layer. The hidden or intermediate layers may act as learnable feature extractors, while the output layer may output the improved image frame. Each layer of the neural network may comprise a number of neurons (or nodes). A neuron receives input that comes either directly from the input data (e.g., low quality image data etc.) or the output of other neurons, and performs a specific operation, e.g., summation. In some cases, a connection from an input to a neuron is associated with a weight (or weighting factor). In some cases, the neuron may sum up the products of all pairs of inputs and their associated weights. In some cases, the weighted sum is offset with a bias. In some cases, the output of a neuron may be gated using a threshold or activation function. The activation function may be linear or non-linear. The activation function may be, for example, a rectified linear unit (ReLU) activation function or other functions such as saturating hyperbolic tangent, identity, binary step, logistic, arcTan, softsign, parameteric rectified linear unit, exponential linear unit, softPlus, bent identity, softExponential, Sinusoid, Sinc, Gaussian, sigmoid functions, or any combination thereof. During a training process, the weights or parameters of the CNN are tuned to approximate the ground truth data thereby learning a mapping from the input raw image data to the desired output data (e.g., identity of object, location, orientation of an object in a 3D scene).

In some embodiments, the deep learning model may be trained using supervised learning or semi-supervised learning. For example, in order to train the deep learning network, pairs of datasets with input image data (i.e., images captured by the camera) and desired output data (e.g., ground truth/label) may be generated by a training module of the system as training dataset. The training datasets may comprise automatically generated or manually generated label data. The term “labeled dataset,” as used herein, generally refers to a paired dataset used for training a model using supervised learning. The term “label” or “label data” as used herein, generally refers to ground truth data. During a training process, the weights or parameters of a deep learning model (e.g., CNN) are tuned to approximate the ground truth data thereby learning a mapping from input data to the desired output.

Reducing the nozzle to ground distance can beneficially improve spot spray accuracy. However, keeping constant and short distance from nozzle to ground on a spray bar of several tenths of meter is challenging. One embodiment of the invention is to decompose the high-resolution nozzle array 240 into smaller segments or modular components 260, each one being mounted on individual height actuators 262 to allow for fast regulation capability. The high-resolution nozzle array height control system 250 may comprise a plurality of modular components each is associated with an independent height control system. The height to ground of a single segment 260 may be independently controlled. The plurality of modular components or segments may or may not have same length. The plurality of modular components or segments may or may not have the same number of nozzles or resolution of nozzles.

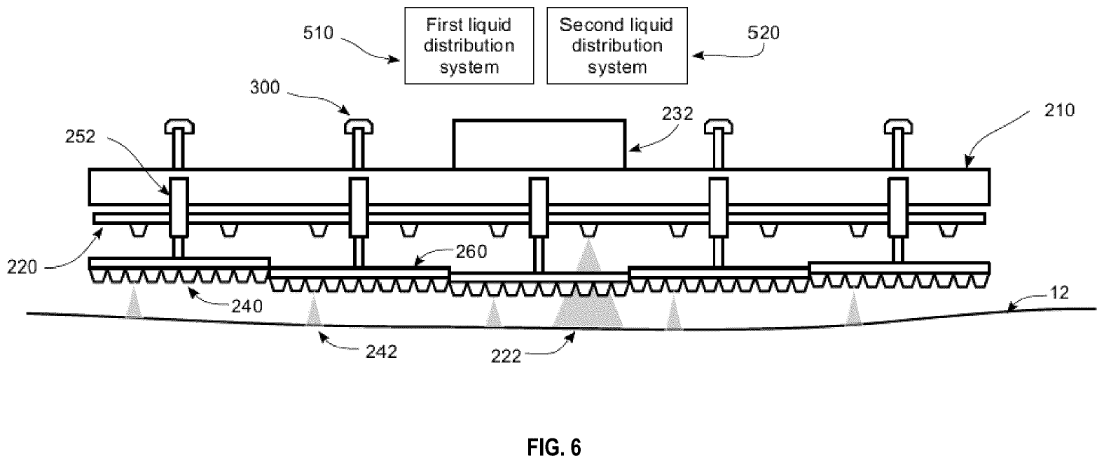

FIG. 6 shows an example of the system where an uneven terrain 12 is sprayed with high spatial resolution spot sprays 242 and the height of each segment 260 with ground is independently measured by the 3D depth sensor 314 of the camera module 300 associated with the corresponding segment 260, and this height measurement is used by the individual height control system 250 of each segment to regulate the height and provide control signal for the height actuator of the corresponding segment, so as to obtain a spray distance as constant as possible for each individual segment. The system, sensor and method for the distance to ground control for each segment can be the same as those described elsewhere herein.

The agricultural system herein may be adapted to perform at least two spraying application modes, one is full application of liquid, for instance to spray fertilizer or fungicide uniformly, continuously or at lower spatial resolution, and the other mode is high-resolution spot spraying application, for instance of non-selective herbicide for selective weeding operation, or insecticide on the crop plants only. FIG. 6 illustrates two liquid distribution systems or spray application modes with their own mixture and pressure. The first application model supplies the low-resolution nozzle array, which can be either operate in full application mode or in low resolution spot spray mode. The second supplies the high-resolution nozzle array. For example, the first and second liquid distribution system may comprise its own reservoir containing a fluid (e.g., agrochemical) to be dispensed. The chemical mixtures sprayed by the low-resolution spot spray and the high-resolution spot spray may be different. For example, the chemical mixtures may comprise different mixtures of a herbicide, fungicide, insecticide, fertilizer, growth stimulant or nematocide sprayed simultaneously by the first and the second spray bars to improve the efficiency of the system.

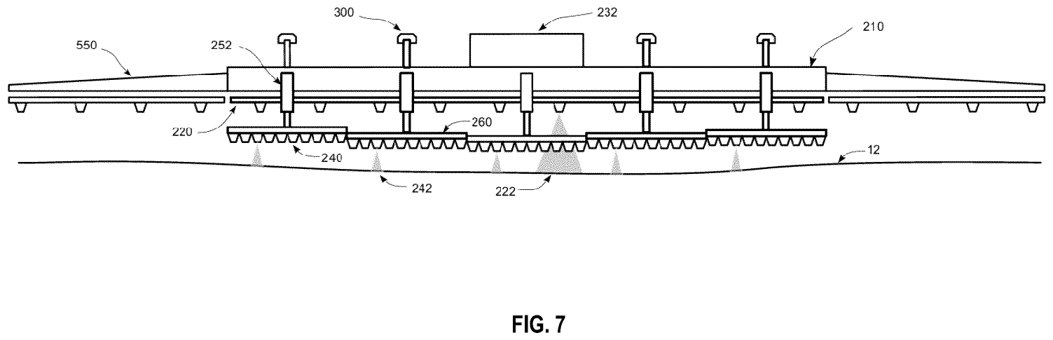

The modularity feature of the system herein may beneficially allow for flexibility to adapt to various spray applications. For instance, the agricultural system herein may be capable of providing a higher throughput in full application mode with the same spraying equipment. In some embodiments, as shown in FIG. 7, extension segments or modular components may be added at the extremities of the spray bar supporting the low-resolution nozzle array. The modular components can be conveniently added to either the low-resolution nozzle spray bar or the high-resolution nozzle spray bar. In some cases, the added modular components may not be equipped with camera modules and may be foldable. By unfolding these segments, the spraying equipment can perform full application with an improved throughput.

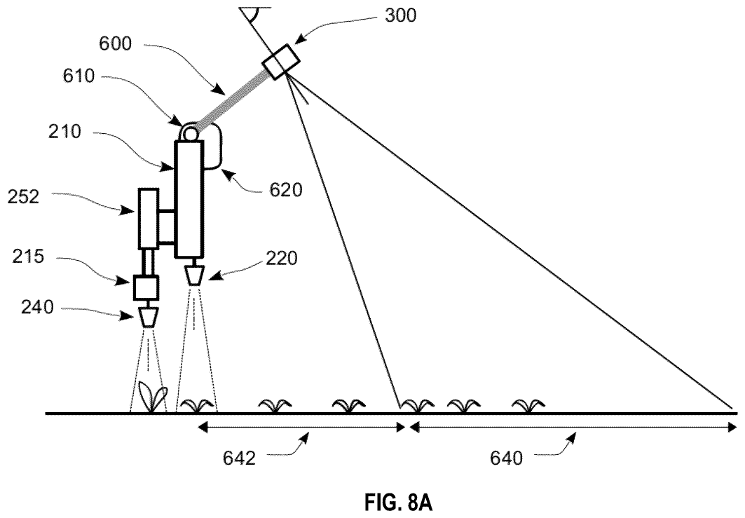

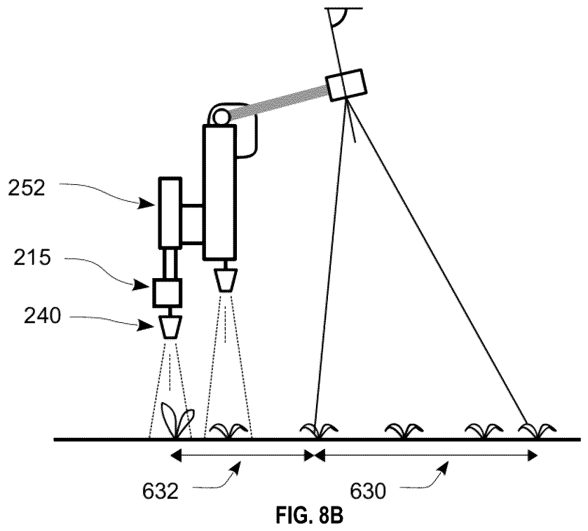

The system and method herein may provide cameras with varying tilt angles. In particular, the tilt angles of the imaging device may be dynamically adjusted depending on a desired speed of and accuracy of the chemical application. FIGS. 8A and 8B show examples of system that control a tilt angle of camera modules based on a desired speed of and accuracy of the chemical application. The camera modules 300 are placed on the extremity of a corresponding mast 600 as illustrated in the example. Each mast 600 is mounted on a motorized rotation system 620 to pivot about an axis extending along the first spray bar 210 as described above.

When the mast is rotated to extend along a vertical direction (not shown), the first spray bar may be folded by segments without collision of the masts with other parts. FIG. 8A shows a first scenario where the tilt angle of the mast 600 is set such that the field of view 640 of the camera of the camera module 300 is directed to a first position at a first distance 642 to the first spray bar 210 in forward direction of the agricultural system resulting in an important distance between the rear side of the field of view and the nozzles. Such configuration is selected when fast operation is needed as this extended distance allows more time for the image processing, which is very often the bottleneck of such systems in terms of speed.

By setting the tilt angle of the mast as shown in FIG. 8B, the field of view 630 is directed to a second position at a second distance 632 to the first spray bar 210 shorter than the first distance 642. The optical axis of the camera being almost vertical in this configuration, the quality of object mapping is better with an increased precision, at the cost of a reduced possible operation speed of the agricultural system due to a shorter distance between the rear side of field of view and the nozzles.

The change of tilt angle between the forward-looking position and the vertical position may be controlled based on a forward speed of the spray equipment. The tilt angle may be switched between two positions. Alternatively, the tilt angle may be changed continuously. In some cases, two different tilt angle values or tilt positions may be selected based on a threshold. For example, when the forward speed is below a pre-defined speed threshold, the tilt angle is at a first value (e.g., vertical or downwards looking), and when the forward speed is above the speed threshold, the tilt angle of the camera may be adjusted to a second value (e.g., forward-looking position). In another example, the tilt angle may be adjusted continuously based on the speed. The tilt angle may be changed from the vertical position when the spray equipment exceeds a first defined speed threshold up to the forward-looking position when the spray equipment exceeds a second defined speed higher than the first one.

Another aspect of the invention relates to a method of operating the agricultural system 100 using visual odometry to detect and track the tri-dimensional or three-dimensional (3D) movement of objects in the 3D coordinate system of the first and second array of nozzles 220, 240 such that the first and second nozzles array control units 280, 282 timely control the first and second array of nozzles 220, 240 according to the position of these objects in the above 3D coordinate system.

The visual odometry according to this method comprises the steps of: i. capturing with the camera 310 a first image of the ground 12 and the objects on the ground; ii. simultaneously capturing with a 3D depth sensor 314 a depth map of the ground and the objects captured in the first image; iii. merging the first image with the depth map to obtain a 3D image; iv. extracting on the 3D image a set of features, such as contour, an edge or any landmark feature of an object, for features tracking, and v. repeating steps i to iv and tracking the movement of the extracted features between two consecutive 3D images as the agricultural system 100 moves along its travel direction to compute the movement of the extracted features in the 3D coordinate system of the first and second arrays of nozzles 220, 240.

Another aspect of the invention relates to a method of operating the agricultural system 100 of FIG. 1 to perform different spraying operations on the cultivated field 10. The first and the second array of nozzles 220, 240 are supplied either by a same liquid distribution system, or by their respective liquid distribution systems 510, 520 as shown in FIG. 6. The first and second control units 280, 282 are operated to control each nozzle of respective first and second array of nozzles 220, 240 to perform in the cultivated field any of the following operations: a. performing low-resolution and high-resolution spot sprays 222, 242 simultaneously; b. performing low-resolution spot spray 222 while high-resolution spot sprays 242 is not performed; c. performing high-resolution spot spray 242 while the low-resolution spot sprays 242 is not performed; d. performing a continuous and homogeneous spray application with the first array of nozzles 220 while the second array of nozzles 240 is not used; e. performing a continuous and homogeneous spray application with the second array of nozzles 240 while the first array of nozzles 220 is not used; f. performing a continuous and homogeneous spray application with the first array of nozzles 220 while the second array of nozzles 240 performs high-resolution spot spray 242; g. performing a continuous and homogeneous spray application with the second array of nozzles 240 while the first array of nozzles 220 performs low-resolution spot spray 222, and h. performing a continuous and homogeneous spray application with the first and second arrays of nozzles 220, 240.

The processing unit, controller or other computing units in the system can be implemented by the one or more processors that may be a programmable processor (e.g., a central processing unit (CPU), a graphic processing unit (GPU), a general-purpose processing unit or a microcontroller), in the form of fine-grained spatial architectures such as a field programmable gate array (FPGA), an application-specific integrated circuit (ASIC), and/or one or more Advanced RISC Machine (ARM) processors.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A system for spraying an area of a cultivated field comprising a spraying equipment, the spraying equipment comprising:
a first supporting structure and a second supporting structure, wherein the first supporting structure and the second supporting structure extend perpendicularly to a travel direction of the system when operating, wherein the first supporting structure comprises a first array of nozzles separated from each other by a first distance, wherein the second supporting structure comprises a second array of nozzles separated from each other by a second distance smaller than the first distance such that a spatial resolution of spot sprays sprayed by the second array of nozzles is higher than a spatial resolution of spot sprays sprayed by the first array of nozzles;
a height control system comprising at least a height actuator to control independently a height of the first supporting structure and a height of the second supporting structures with reference to a ground;
a camera system configured to acquire an image of objects, wherein the objects comprise at least a portion of a plant and the ground ahead of the first supporting structure or the second supporting structure in the travel direction of the system;
a processing unit configured to:
a) perform object recognition to identify the objects on the acquired image;
b) generate a mapping of the objects on a coordinate system of the system,
c) continuously track a position of the objects on the mapping; and
a control unit configured to control the first array of nozzles and the second array of nozzles to perform a low-resolution spot spraying and a high-resolution spot spraying respectively on different objects based at least in part on the mapping of the different objects on the coordinate system of the system and the position of the different objects on the mapping.

2. The system of claim 1, wherein the height control system comprises one or more primary height actuators arranged to control the height of both the first supporting structure and the second supporting structure with reference to the ground and one or more secondary height actuators arranged to move the first supporting structure or the second supporting structure relative to one another.

3. The system of claim 1, wherein the spraying equipment comprises a distance measurement sensor to measure a distance from the first supporting structure or the second supporting structure to a ground surface.

4. The system of claim 3, wherein the distance measurement sensor is mounted along the first supporting structure or the second supporting structure.

5. The system of claim 3, wherein a distance information measured by the distance measurement sensor is transmitted to the control unit to regulate the height of the first supporting structure and the height to the second supporting structure relative to the ground surface as a function of the distance information.

6. The system of claim 3, wherein the height control system regulates the distance between the first supporting structure and the ground as a function of information comprising a distance information from the distance measurement sensor, data from a 3D depth sensor, and motion information of the second supporting structure.

7. The system of claim 1, wherein the second array of nozzles comprises a plurality of segments each comprising a series of nozzles, and wherein the height control system comprises an actuator per segment to independently control a distance of each segment to the ground.

8. The system of claim 1, wherein the first supporting is adapted to be extended laterally, either by translation or by unfolding of one or more of supporting structure extensions so as to provide a larger working width for full spray application to achieve continuous and homogeneous spray application.

9. The system of claim 8, wherein each of the one or more supporting structure extensions comprises a low-resolution nozzle array and a distance measurement sensor.

10. The system of claim 1, wherein the spraying equipment further comprises a fluid distribution system arranged to provide to the first arrays of nozzles a first chemical mixture and provide to the second arrays of nozzles a second chemical mixture, such that the spraying equipment sprays the first and the second chemical mixtures in a single passage, wherein the first and the second chemical mixtures comprise a herbicide, fungicide, insecticide, fertilizer, growth stimulant or nematocide.

11. The system of claim 10, wherein the control unit is operated to control each nozzle of the first arrays of nozzles and the second arrays of nozzles to perform on the cultivated field any of the following operations:
a. performing a low-resolution spot spraying and a high-resolution spot spraying simultaneously,
b. performing the low-resolution spot spraying while the high-resolution spot spraying is not performed,
c. performing the high-resolution spot spraying while the low-resolution spot spraying is not performed,
d. performing a continuous and homogeneous spray application with the first array of nozzles while the second array of nozzles is not used,
e. performing a continuous and homogeneous spray application with the second array of nozzles while the first array of nozzles is not used,
f. performing a continuous and homogeneous spray application with the first array of nozzles while the second array of nozzles performs the high-resolution spot spraying,
g. performing a continuous and homogeneous spray application with the second array of nozzles while the first array of nozzles performs the low-resolution spot spraying,
h. performing a continuous and homogeneous spray application with the first array of nozzles and the second array of nozzles.

12. The system of claim 1, wherein the camera system further comprises a 3D depth sensor arranged to measure a distance between any point of the objects on the acquired image, wherein the mapping of the objects on the coordinate system of the system is based at least in part on the distance measured by the 3D depth sensor, and wherein the mapping is used for correction of a horizontal mapping error caused by a height difference between an estimated object plane and a real object position.

13. The system of claim 1, wherein the processing unit is configured to further i) merge the acquired image of the objects and a depth map of the objects to obtain a 3D image, ii) extract on the 3D image a set of features comprising an edge of an object for tracking the position of the object.

14. The system of claim 1, wherein an optical axis of a camera of the camera system is tilted around a rotation axis placed horizontally and perpendicularly to the forward direction to set a first distance and a second distance, wherein the second distance is smaller than the first distance, wherein the first distance or the second distance is a distance between an edge of the acquired image of an area of the cultivated field and a projection on the ground of the first supporting structure or the second supporting structure, and wherein the optical axis is tilted to:
set the first distance when a low-resolution spot spraying is used, thereby increasing the time for computation and consequently to allow speed increase of the system,
set the second distance when a high-resolution spot spraying is used, wherein the speed of the system is limited to allow high-precision mapping of one or more plants in a ground reference.

15. A system for spraying an area of a cultivated field comprising a spraying equipment, the spraying equipment comprising:
a supporting structure extending perpendicularly to a travel direction of the system when operating, wherein the supporting structure comprises an array of nozzles;
a height control system comprising a height actuator to control a height of the supporting structure with reference to a ground;
a camera system configured to acquire an image of objects, wherein the objects comprise at least a portion of a plant and the ground ahead of the supporting structure in the travel direction of the system;
a processing unit configured to:
a) perform object recognition to identify the objects on the acquired image;
b) generate a mapping of the objects on a coordinate system of the supporting structure;
c) continuously track a position of the objects on the mapping,
a control unit configured to selectively control the array of nozzles to perform spot spraying on the objects as a function of the position of the objects on the mapping with respect to a position of the supporting structure ; and
a 3D depth sensor arranged to measure a distance between a point of the objects on the acquired image, wherein the mapping of the objects on the coordinate system of the supporting structure is based at least in part on the distance measured by the 3D depth sensor, and wherein the mapping is used for correction of a horizontal mapping error caused by a height difference between an estimated object plane and a real object position.

16. The system of claim 15, wherein the estimated object plane is obtained based on a distance measured by a measurement sensor located along the supporting structure.

17. The system of claim 15, wherein the 3D depth sensor comprises a laser scanning system with time of flight (LIDAR), triangulation, a stereovision system, a time-of-flight camera, or a structured light depth camera.

18. The system of claim 15, wherein the camera system comprises at least two cameras arranged to acquire simultaneously respectively a first and a second set of images of the ground ahead of the first supporting structure or the second supporting structure, and a stereovision computing unit configured to compute a 3D image of the objects based on the first and second sets of images.

19. The system of claim 18, wherein the processing unit is configured to extract on the 3D image a set of features comprising an edge of an object for tracking the position of the object and compute a movement of the extracted set of features in the coordinate system.

20. The system of claim 15, wherein the camera system is rotatably mounted on a support of the spraying equipment, and wherein a tilt angle of an optical axis of a camera of the camera system with reference to the ground is varied to modify a distance between an edge of an acquired image of an area of the cultivated field and a projection on the ground of the first supporting structure or the second supporting structure.

21. The system of claim 20, wherein the support is a mast extending forward from the first supporting structure or the second supporting structure, and wherein the mast comprises a motorized rotation system for controlled, accurate and repeatable rotation of the mast around an axis extending horizontally and perpendicularly to the travel direction of the system.

22. The system of claim 15, wherein the processing unit is configured to further i) merge the acquired image of the objects and a depth map of the objects to obtain a 3D image, ii) extract on the 3D image a set of features comprising an edge of an object for tracking the position of the object.

23. The system of claim 15, wherein an optical axis of a camera of the camera system is tilted around a rotation axis to set a first distance and a second distance, wherein the second distance is smaller than the first distance, wherein the first distance or the second distance is a distance between an edge of the acquired image of an area of the cultivated field and a projection on the ground of the supporting structure, and wherein the optical axis is tilted to:
set the first distance when only low-resolution spot spraying is used, thereby increasing the time for computation and consequently to allow speed increase of the system,
set the second distance when only high-resolution spot spraying is used, wherein the speed of the system is limited to allow high-precision mapping of one or more plants in a ground reference.

24. A system for spraying an area of a cultivated field comprising a spraying equipment, the spraying equipment comprising:
a supporting structure extending perpendicularly to a travel direction of the system when operating, wherein the supporting structure comprises an array of nozzles;
a height control system comprising a height actuator to control a height of the supporting structure with reference to a ground;
a camera system configured to acquire an image of objects, wherein the objects comprise at least a portion of a plant and the ground ahead of the supporting structure in the travel direction of the system;
a processing unit configured to:
perform object recognition to identify the objects on the acquired image;
generate a mapping of the objects on a coordinate system of the supporting structure;
continuously track a position of the objects on the mapping,
a control unit configured to selectively control the array of nozzles to perform spot spraying on the objects as a function of the position of the objects on the mapping with respect to a position of the supporting structure,
wherein an optical axis of a camera of the camera system is tilted around a rotation axis to set a first distance and a second distance, wherein the second distance is smaller than the first distance, wherein the first distance or the second distance is a distance between an edge of the acquired image of an area of the cultivated field and a projection on the ground of the supporting structure, and wherein the optical axis is tilted to:
set the first distance when a low-resolution spot spraying is used, thereby increasing the time for computation and consequently to allow speed increase of the system,
set the second distance when a high-resolution spot spraying is used, wherein the speed of the system is limited to allow high-precision mapping of one or more plants in a ground reference.

25. The system of claim 24, wherein the processing unit is configured to extract on the acquired image a set of features comprising an edge of an object for tracking the position of the object and compute a movement of the extracted set of features in the coordinate system.

26. The system of claim 24, wherein the camera is rotatably mounted on a support of the spraying equipment.

27. The system of claim 26, wherein the support is a mast extending forward from the supporting structure, and wherein the mast comprises a motorized rotation system for controlled, accurate and repeatable rotation of the mast around an axis extending horizontally and perpendicularly to the travel direction of the system.
